(19) United States
(12) Patent Application Publication
(10) Pub. No.: US 2003/0215777 A1
(43) Pub. Date: Nov. 20, 2003

(54) System and method for skateboard performance and trick instruction

(76) Inventor: Jared Loveless, Greenport, NY (US)

Correspondence Address: JARED LOVELESS, 502 CARPENTER ST., GREENPORT, NY, 11944, US

(21) Appl. No.: 10/402,910

(22) Filed: Mar. 28, 2003

Related U.S. Application Data
(60) Provisional application No. 60/368,678, filed on Mar. 28, 2002.

(51) Int. Cl. G09B 9/00; G09B 19/00; A63B 69/00

(52) U.S. Cl. 434/247

(57) ABSTRACT

The present invention relates to systems and methods useful in instructing or teaching a person how to perform tricks on a skateboard.

### FIELD OF THE INVENTION

This application claims priority to U.S. Provisional Application serial No. 60/368,678, filed Mar. 28, 2002, which is incorporated by reference herein (including drawings). The invention relates to systems and methods prepared to provide instruction to a person (a user) performing or learning to perform tricks on a skateboard.

### BACKGROUND OF THE INVENTION

Various activities require the proper placement of an individual's body and limbs in order to perform the activity. For example, activities such as dancing, martial arts, or boxing all require proper body placement and/or movement in coordination with proper limb placement and/or movement. Methods for providing instructions regarding the proper manner by which an individual's body and limbs should be moved or held, have come in a variety of forms.

In dancing, for example, diagrammatic charts have been created that illustrate the proper placement for an individuals feet when performing a particular dance or dance routine. Such charts attempt to clearly illustrate not only where an individuals feet should be placed, but also the angle at which the feet are in relation to each other, and the motion or steps an individuals feet should take in order to perform the dance or dance routine. The diagrams are generally provided in flow-chart format, providing a set pattern of steps for the individual to follow. Such charts have also been prepared for activities such as boxing and martial arts, illustrating how a boxer or karate participant should stand and where the individual's feet should be placed. Generally such diagrammatic charts contain simple black or white colored ‘footprints’ or circular/square ‘dot’ style images or illustrations on a piece of paper or plastic that the user can place on the floor or a wall. Such charts have also been reproduced on longer lasting materials such as laminated paper, plastics, wood, cement, ceramic tile, or etched or carved into similar materials in order to withstand an individual actually stepping on the diagram in order to facilitate the learning experience by actually stepping on or touching the diagramed steps.

More advanced forms of diagrammatic instructional charts have also comprised images of a human form conducting the activity being taught. For example, charts illustrating the motion of a particular dance step, boxing motion, or martial art style, have been prepared that contain line drawn, or photographic images of an individual performing the motion to be taught, allowing an individual to more accurately replicate the movement by imitating the pictured figure. Advances in such instructional techniques have resulted in, for example, audio or motion picture sources which provided further instruction regarding the particular activity, diagrams with sound and/or light sources that lead an individual through the proper motions, interactive diagrams that are used in conjunction with computer software, or DVD programs that enable a person to perform a certain activity while, for example, playing a video game or making music based on proper vs. improper foot or hand motion.

Currently, there are many forms of instructional aids available that combine the use of diagrammatic charts with video taped, digitally captured and/or rendered or Digital Video Disc (DVD and or DVD/ROM) instructional motion pictures and audio instruction to perform a variety of activities, from dance routines to creating shelf systems or even repairing an automobile. Such aids have also been prepared for use on a computer by combining digital audio video performances with interactive computer software programs thereby providing yet another helpful and instructional tool.

The present invention relates to the use of one or more particular maneuver diagrams alone, or in conjunction with an instructional motion picture source to teach or instruct an individual preferred, or proper placement of the body and limbs when performing activities and maneuvers on a skateboard.

### SUMMARY OF THE INVENTION

In accordance with the present invention, systems and methods are described for instructing an individual in preferred or proper placement of the individual's (the user) body and limbs when performing maneuvers, such as tricks or stunts on a skateboard. The systems and methods comprise a maneuver diagram which illustrates where the individual's feet and body should be placed when performing a particular maneuver and a motion picture source comprised of sequential images of a particular maneuver being performed by an experienced instructor/skilled artisan. The motion picture source can also provide highlights for proper foot and body movement and placement in direct reference to the diagram.

As used herein, the phrase “skilled artisan” refers to the person within the motion picture source who is pictured and shown, performing one or more particular skateboard maneuvers correctly. The skilled artisan is a skateboard auteur, an advanced skateboard rider who has mastered the tricks and maneuvers that are diagrammed on the maneuver diagram.

By the terms “trick(s)” and/or “maneuver(s)” is meant activities performed on a skateboard wherein such activities are characterized by an individual using his/her feet and body to manipulate the skateboard, bringing the skate board off of the ground, rotating or flipping the skateboard along its horizontal, perpendicular, vertical, linear or width-related planes, sliding his/her feet along the skateboard, stamping, stomping, kicking portions of the skateboard causing the skateboard to rotate or flip as described, or leaping, jumping or sliding along or over surfaces on a skateboard. The terms can be used interchangeably.

As used herein, “skateboard” refers to the well-known device comprising four or more wheels connected to a flat board like surface independently, or as sets of two axel/truck associated pairs of wheels, used for both professional, amateur and leisure sport related activities. It would be understood by one of skill in the art that the diagram of the present invention system can be used to provide instruction for the performance of maneuvers on any skateboard.

In an aspect of the present invention the maneuver diagram of the system and method comprises starting symbols, such as lines and/or characters illustrating where an individuals feet and/or body are placed at a starting step of a trick or maneuver in relation to a skateboard, and provide directional or movement symbols identical or different from the starting symbols, such as for example, dotted lines, or solid directional lines, shapes or the like, indicating the direction the individuals feet and/or body should move in relation to the skateboard to perform the trick or maneuver, and completion symbols which represent where an individuals feet and/or body should be placed at the completion of a trick or maneuver. Preferably, the symbols of the diagram are prepared to be easily detected by an individual, and the diagram is prepared in a manner allowing for it to be secured to the topside of a skateboard. For better detection the diagram can be prepared using colors that are chromatically opposite, for example, black symbols on a white diagram, or orange symbols on a blue diagram. The maneuver diagram can be prepared with center, nose and tail, symbols serving as instructional point that allow the diagram to be secured to a skateboard with optimal positioning with relation to the center, nose and tail of the skateboard. The symbols of the maneuver diagram can be two or three dimensional images or auditory symbols which emit sounds when contacted by a user of the disclosed system and method.

As used herein, the term “diagram” and phrase “maneuver diagram” are used interchangeably with reference to the arrangement of symbols on a piece of material for attachment to a skateboard, or on the skateboard itself, prepared to illustrate the motions and placement of an individuals body and feet when performing a skateboard maneuver.

The diagram of the invention system is prepared to illustrate the proper body and foot location and movement for at least one, and as many as ten skateboard maneuvers. In an embodiment of the invention, the diagram comprises starting, directional or movement, and completion symbols for placement and movement of an individual's body and feet, and skateboard movement symbols which illustrate the direction(s) the skateboard should move to perform a certain maneuver or trick. Different maneuvers or tricks are illustrated through the use of different directional or movement symbols in combination with the same or different starting and completion symbols for both the individual's body, feet and the skateboard.

In another embodiment, the diagram of the invention system, which can comprise symbols for foot and body placement and motion and additional symbols for skateboard movement and motion, is used in conjunction with a motion picture presentation and/or rendition of one or more particular skateboard maneuvers or tricks. In such an embodiment, the diagram which can comprise symbols illustrating the motions for an individuals feet, body and/or skateboard motion and movement symbols is arranged to have specific symbols that are replicated and can be highlighted, within the motion picture to provide an individual a reference guide for maneuver motions. In such an embodiment, for example, symbols in the maneuver diagram are similar in color and/or shape, or identical to symbols in the motion picture, however the motion picture provides both the images of a skilled artisan performing a selected maneuver with the addition of superimposed and or highlighted, symbols which are similar in color and/or shape, or identical to the diagrammatic symbols, that more clearly illustrate the manner by and through which the diagrammed movement, motion and placement of the individual's feet, board and body are accomplished.

It is understood, that the symbols can be various shapes and colors and/or the symbols can also be auditory either simultaneously or independently, causing alert related sounds should a user succeed or fail to move through a particular motion in a desired manner or at a particular speed.

Preferably, the motion picture component of the present invention systems and methods comprises images of an individual performing a particular maneuver for which a maneuver diagram is provided, and the motion picture has reference animated and/or stationary symbols similar in color and/or shape, or identical to the symbols of the diagram, which a user can view to determine the motions and placement of their feet on a skateboard in direct reference to the skilled artisan's motions when performing the maneuver correctly.

By “motion picture” is meant a collection of sequential images that, when viewed in the correct sequence provide the appearance of real or natural motion, for example as in a movie or film. The term, motion picture, is well known, and non limiting examples of types of motion pictures useful in the practice of the present invention system and method(s), with or without an accompanying audio source, are: flip-books, videotapes, digital movies, digital video discs (DVD), Video compact disc (VCD), computer based motion picture files such as mpg, mpeg, avi., .mov, .qtw, .rm, .swf and like formats, LCD pixel displays, pixel generated sequential images, tft images and other like formats for viewing motion pictures.

As used herein, “flip-books” refers to hand held soft-cover books or booklets comprised of a succession of images, printed on pages of paper or plastic, of an individual performing one or more particular skateboard maneuvers, that, when flipped from page to page in quick succession provide the appearance of motion, or a movie. The images in a flip-book can be computer generated/animated characters, sequential photographs of an actual person performing the maneuver, and the images can be color or black and white or a combination thereof. The concept of small soft cover books being used to provide the appearance of motion by placing a sequence of images on the pages of the books is well know and not a limiting aspect of the present invention. In preferred embodiments a flip-book comprises at least 1 and up to 5 skateboard maneuvers represented by any number of sequential images necessary to provide a moving representation of the particular skateboard maneuver. More preferably a flip book comprises 2 skateboard maneuvers.

It would be recognized and understood that the number of images required to illustrate the motion of a particular skateboard maneuver can fluctuate based on the detail of the motion desired. However, such limitations are not related to the present invention as the requirement of the flip-book is to provide a moving representation of a particular skateboard maneuver that is illustrated and represented by the accompanying maneuver diagram. More than one flip-book, or animated, motion picture representation of a particular maneuver can be used in conjunction with an individual maneuver diagram. For example, a man, woman, child, and even other bipedal figures can be represented performing the maneuver. In a preferred embodiment, a flip-book contains at least 35 sequential images of a maneuver and at least 120. Again, of utmost importance is that the flip-book provide sequential images, that when flipped rapidly from page to page, the images of the skateboard maneuver being performed appear to move as in a movie. Furthermore, the images of the motion picture can comprise reference symbols identical to, or of the same color, or sound, as symbols within the invention maneuver diagram. The reference symbols of the motion picture source, such as a flip book, can provide an animated reference within the motion picture for the motion, location and placement of the users feet, body and skateboard as diagramed and provided in the maneuver diagram of the present invention. Such a combination provides an individual who uses the present invention a system and method(s) to both interact with the invention diagram by reviewing the representative symbol illustrations within the motion picture source in reference to their own feet, body and skateboard motions and placement. Viewing the motion and placement of the feet, body and skateboard of the individual depicted in the motion picture source in conjunction with animated reference symbols superimposed within the motion picture that are similar or identical in color and/or shape to the symbols of the diagram increase the descriptive and instructional ability of the present invention system and method, in comparison to still photographs or written descriptions.

In another related embodiment, a method is provided for instructing an individual to perform maneuvers on a skateboard comprising the steps of providing a diagram, comprising symbols which illustrate the start, direction and movement, and completion locations for an individual's body, feet and skateboard movement/motion, for performing one or more skateboard maneuvers, and a motion picture source comprising sequential images which illustrate the maneuver as performed by a skilled artisan wherein the motion picture, or movie, has symbols which are similar in color and/or shape, or identical, to the symbols of the maneuver diagram. The diagram is prepared in a manner that allows it to be placed directly on a users skateboard, or the skateboard can be prepared in a manner having the top of the skateboard comprising the diagram of the one or more maneuvers in a readily visible location for the skateboard rider (user).

Preferably, the diagram comprises at least one and up to ten maneuvers illustrated as flow diagrams of symbols, where the symbols can comprise shapes, characters, words and/or dotted lines representing where an individual's feet and body should be placed at the start of the maneuver, where the individual's feet and body should move during a maneuver and where the individual's feet and body should end to complete the maneuver. Moreover, the diagram can comprise additional symbols for indicating the direction and motion of the skateboard at the beginning, during, and at the end of one and up to ten maneuvers. More preferably the diagram comprises at least one and no more than 5 maneuvers illustrated as described herein.

With regard to a particular aspect of the present invention, the invention diagram is comprised of at least one and up to three sections, where the diagram has sections, such as for example a center section, a nose section (front) and a tail section (back). Each section is prepared to be contacted to, and/or attached to, the top of a skateboard at the respective portions, center, nose and tail. It would be understood that the nose and tail section are relative to the direction the skateboard is pointing, however, once the diagram is attached to the top of the skateboard, the nose and tail portion are determined by the characters, symbols and/or words representing the nose or tail. Sections of the diagram can be prepared simultaneously as one entire diagram comprised of a center, front and back section as individual sections that can be used together and interchangeably. For example, a particular skateboard maneuver may require only an additional tail portion of the diagram to be changed in relation to the rest of the diagram and in such a case, only the tail section would have to be applied to the skateboard.

In a preferred embodiment, the diagram is prepared for attachment to the skateboard in a permanent manner, such as a sticker (paper, plastic or other material with an adhesive backing) or by application through painting or other adhesive methods.

In another embodiment, the diagram is prepared for attachment to the skateboard in a removable manner, having attachment portions for its removal, such as screws, buttons or other like mechanisms.

In yet another embodiment, the diagram is prepared in sections that can be ‘mixed and matched’ with other sections in order to add or remove the number of maneuvers that are diagrammed.

The phrase, “mixed and matched” as used herein, refers to the formation of several tail, nose and center sections, that represent particular maneuvers, and that can be used interchangeably to diagram the manner by which different maneuvers are performed. In such a case, a center section can be used with different tail and/or nose sections, and tail and/or nose sections can be used with different center sections. For example, certain skateboard tricks have steps that are common, for example in the very beginning or end of the maneuver, and in such a case the steps can be represented for a certain portion of the skateboard maneuver diagram be it the front, center or back, portion or part of the maneuver diagram and skateboard. In such a case, it would be advantageous to have a ‘mixed and matched’ modular design of the maneuver diagram in order to provide the user the opportunity to advance their learning experience through modular addition.

It would be understood, that the invention diagram can be provided separate from a skateboard and prepared in a manner that allows for it's attachment to a skateboard. Attachment can be by adhesive backing as in, for example a sticker, velcro type attachment systems, tape or glue type adhesive systems, button, or screw-on, and the like. It is also understood that the maneuver diagram of the invention, can be provided to an individual configured on a piece of paper or plastic, or arranged as a stencil for spray painting or ink drawing. The diagram of the present invention can also be a part of the skateboard top, painted, etched, carved, or sealed thereon using any of the methods for adding decorations to the top portion of a skateboard, which are well known in the art.

It would be understood that within certain embodiments of the present invention the maneuver diagram can comprise electronic components such as touch pads, LED's, liquid crystal view ports, insets or ribbon like wired connections and leads, circuit and computer like systems, ports and connections and light sources and or reflectors. Such additions can be useful by providing additional visual and/or aural indicators for the exact location of an individuals foot and body on the diagram and thusly on the skateboard which lies underneath, or in which the diagram is placed. Furthermore, such additions can be used to interact with other such features and with the user by providing visual and/or aural indicators for the completion of, or incompletion of, a maneuver based on foot placement and the speed at which the maneuver is performed. These type of embodiments can be configured to react to proper and/or improper placement of an individuals feet, and to react and interact with the individual upon completion of the specific maneuver. In such cases, the diagram and circuitry that relates to the interactive components can be part of the diagram, inset within the paper and/or plastic portion of the diagram, painted or etched on the paper and/or plastic portion of the maneuver diagram, or the interactive components can be within or on the skateboard itself.

Other features and advantages of the invention will be apparent from the following detailed description of the preferred embodiments thereof, and from the claims.

### DETAILED DESCRIPTION OF THE INVENTION

The drawings will first briefly be described.

### DRAWINGS

FIG. 1 displays a representation of a portion of the maneuver diagram considered the ‘nose’ or the ‘front’ end of the board.

FIG. 2 displays a representation of a portion of the maneuver diagram considered the center portion of the board.

FIG. 3 displays a representation of a portion of the maneuver diagram considered the “tail” or the “rear” of the board.

FIG. 4 displays a representation of a one piece maneuver diagram comprising the nose, center and tail portions as one piece.

FIG. 5 displays a skateboard with a maneuver diagram attached on its top surface, the surface where a user would place his/her feet.

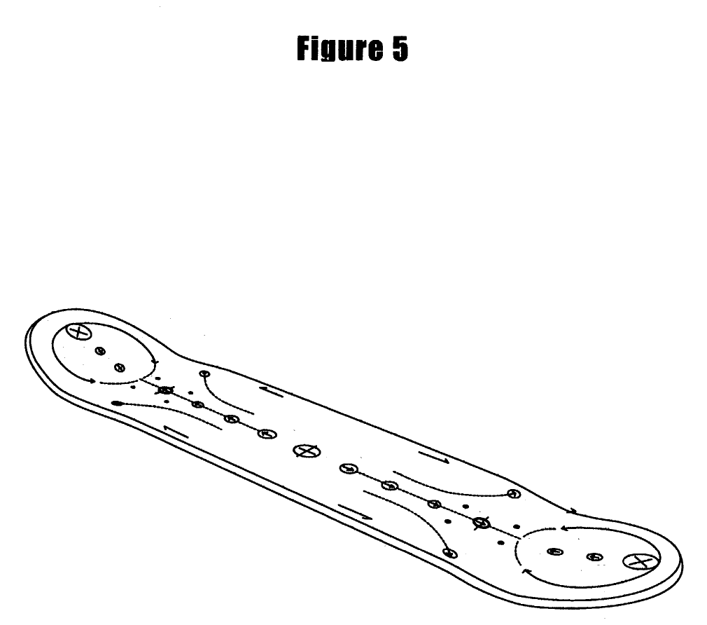

### DESCRIPTION OF PREFERRED EMBODIMENTS

The present invention system(s) and method(s) provides a series of motion picture sources, such as flip books, which allow an individual a chance to witness the motion of a particular skateboard maneuver (the movements of the body, feet and skateboard) as they are performed by a skilled artisan. In a preferred embodiment, the motion picture source, such as a flip book, will be provided separate, yet in conjunction with a maneuver diagram that illustrates the locations and motions of an individuals feet and body during the performance of a skateboard trick or maneuver. The motion picture source, or, for non-limiting example, the flip book, can comprise sequential images which can be rapidly flipped from one to the other providing a motion picture of at least one and up to 5 particular skateboard maneuvers. Key movements of particular maneuvers are highlighted by, for example, the superimposition of symbols within the motion picture, where the superimposed symbols can move, animated, with the character in the motion picture, and are coordinated with identical or similar symbols of the maneuver diagram on the surface of the skateboard. The invention system provides an individual with superior instruction by allowing the individual a way to follow the motions of his/her feet and body in relation to the maneuver diagram and by viewing the skilled artisan within the motion picture source in conjunction with the superimposed symbols which relate to symbols of the maneuver diagram, resulting in the instruction of key movements and motions of the maneuver.

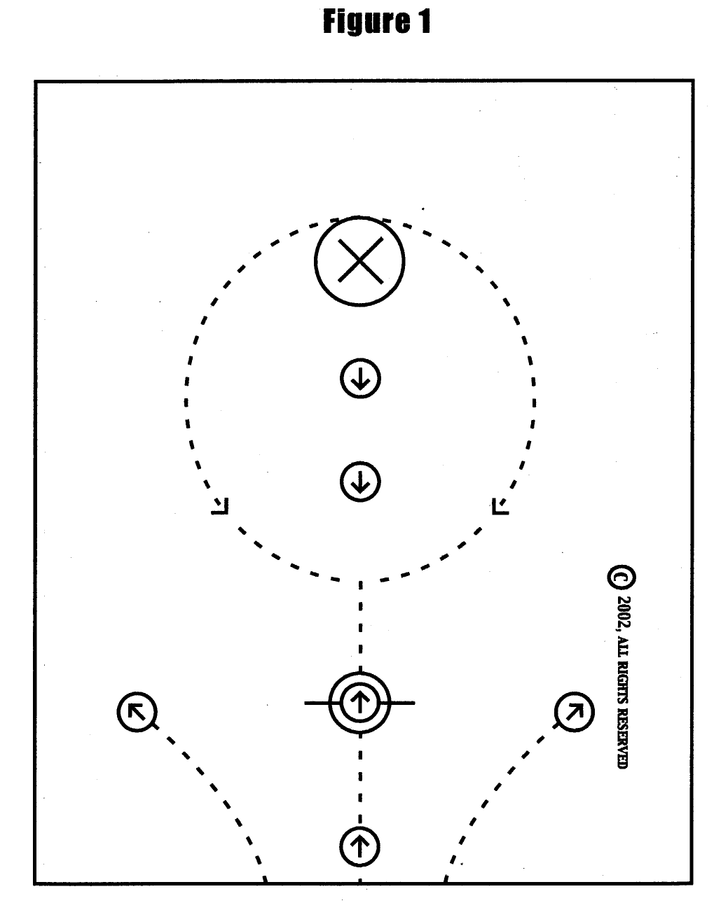

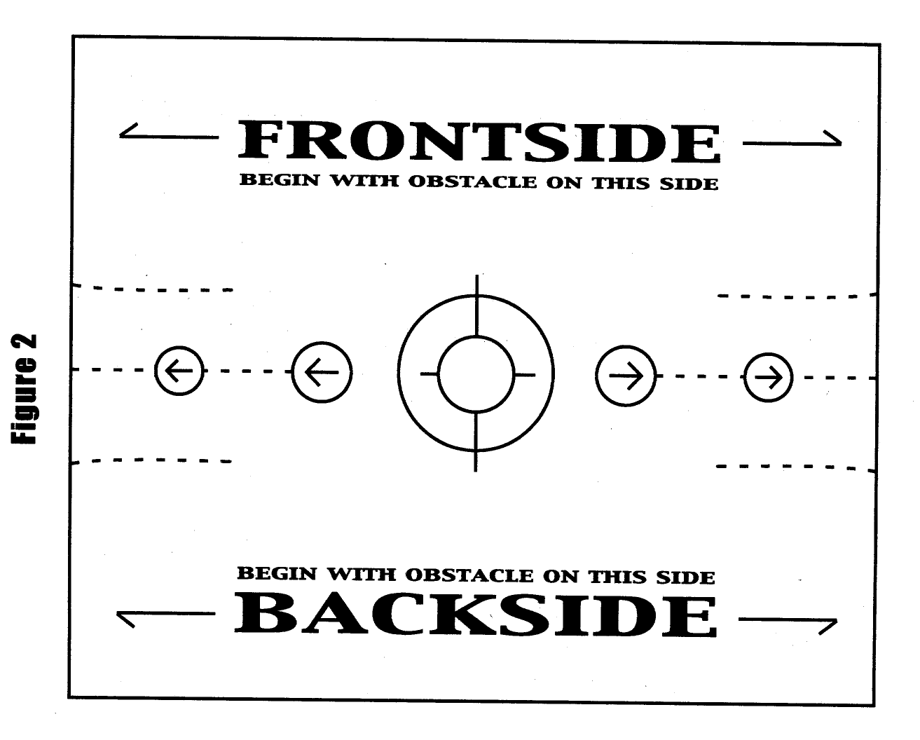

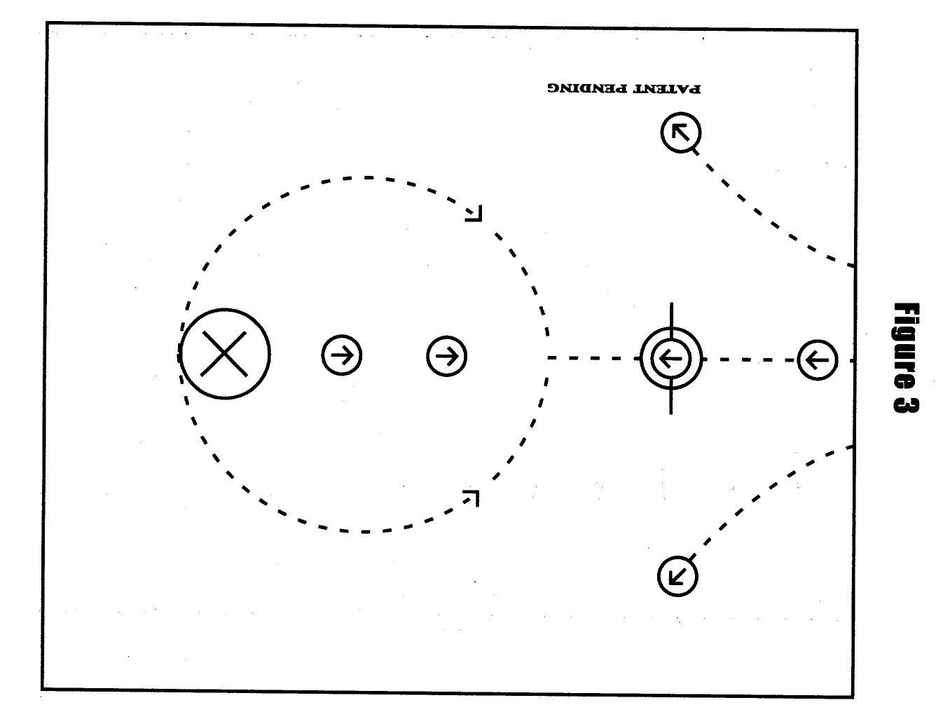

FIGS. 1, 2 and 3 provide exemplary illustrations of an embodiment of a maneuver diagram. FIG. 1, represents the portion of the maneuver diagram that would be placed on one end of the top of a skateboard, considered the ‘nose’ or ‘front’ end. FIG. 2, represents the portion of the maneuver diagram that would be placed in the center of the skateboard. In preferred embodiments, the center portion comprises additional symbols which are used to place the center portion of the maneuver diagram as near to the exact center of the skateboard top surface as possible. FIG. 3, represents the portion of the maneuver diagram that would be placed at one end of the top of the skateboard, considered the ‘tail’ end.

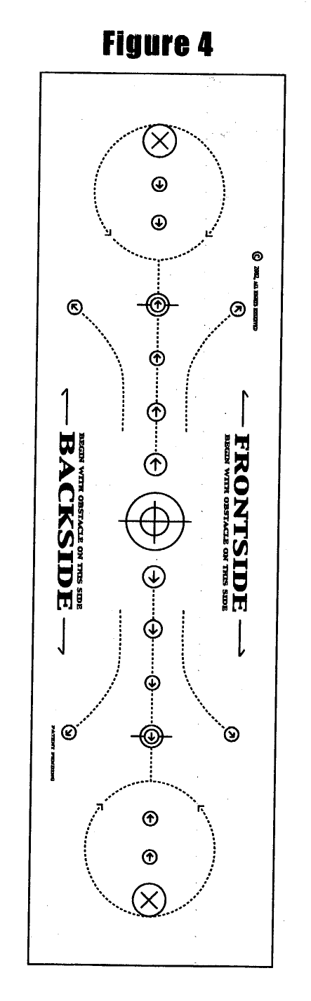

The maneuver diagrams of FIGS. 1, 2 and 3, while provided as three separate pieces for exemplary purposes, can be arranged as one long diagram, FIG. 4, for placement on a skateboard top surface. In preferred embodiments, the maneuver diagram is provided as one and up to three portions. As discussed herein the maneuver diagrams are prepared in a manner that allows for secure attachment to the top of a skateboard. In other embodiments, as described herein, the maneuver diagram can be part of the top of the skateboard, where it is painted, etched, carved or sealed, or other like methods of manufacture, to the top portion of the skateboard.

The maneuver diagrams as shown in Figures, comprise symbols and characters that are used by an individual to determine the proper placement of their body and feet in relation to areas of the skateboard on which the diagram is placed. Furthermore, the symbols and characters of the diagram correlate with symbols and characters that are superimposed and part of a motion picture source which shows a particular skateboard maneuver being performed in a movie, by a skilled artisan. As discussed earlier, the motion picture source can comprise various forms and for exemplary and non-limiting purposes the motion picture source is described in an embodiment of the invention as a flip-book comprised of a series of sequential images that create the illusion of motion when flipped rapidly from page to page that further comprises additional instructions relating to the selected maneuver. However, the motion picture source can be a cell phone with a downloaded digital movie, or so configured as to allow download of sequential images of a particular maneuver, a motion picture source can be a video game component, such as a hand held video game with a cartridge comprising several digitally stored motion picture sources, and as it would be understood by one of skill in the art, the motion picture source could be a small portable television source prepared to provide the user with the particular motion picture representative of the maneuver diagram and used in conjunction with the same in order to accomplish the particular skateboard maneuver.

Generally, symbols and characters of the maneuver diagram represent start locations, motion paths and end/stop locations for an individual's body and/or feet on the surface of the skateboard on which the diagram is secured. For example, in the figures provided, dotted or dashed lines represent motion steps where an individuals foot should slide or move on the surface of the skateboard. Other symbols, such as the circles containing arrows represent places where an individuals feet should move as well. Stop locations, where an individuals feet should be placed at the end of a maneuver, or start locations where an individuals feet should be placed to begin an maneuver, are represented by circles having ‘x’ indicators or ‘target’ like symbols. The symbols of the figures are provided as non-limiting examples. One of ordinary skill in the art would recognize that the purpose of the symbols is to provide locations for the placement and motion of and individual's feet and body, and could be represented by colored squares, circles or other geometric shapes so long as they are defined to the user of the maneuver diagram.

With regard to the figures, there are additional solid and dotted lines having arrows that illustrate the manner by which the skateboard itself should be manipulated in order to perform a particular maneuver. Characters and words can also be arranged on the diagram to provide further instruction for a maneuver.

Preparation of maneuver diagrams is done by examining the motion of a skilled artisan's feet and body when a skateboard maneuver is performed. By noting the location of the skilled artisan's feet and they way in which his/her feet and body move and relocate when performing a skateboard maneuver, different maneuver diagrams for a variety of different skateboard tricks can be prepared. Such additional diagrams are within the scope of the present invention, and would be recognized as simple reproductions of the presently disclosed invention. The method for preparing such maneuver diagrams can comprise obtaining motion pictures of a skilled artisan performing a skateboard maneuver and analyzing the motion of the artisan's body and feet and translating the motion into a diagram having symbols indicating start location, movement and end location of the artisan's body and feet. Another method for preparing such a maneuver diagram is by asking and interviewing an advanced skateboard user the way in which he or she prefers to manipulate his/her body and limbs when performing a particular maneuver or sequence of maneuvers. Sequential still photos of a skateboard maneuver can be useful as well. It would be understood that the construction of a maneuver diagram also comprises the consideration of the size of the skateboard. However, the movement of the artisan's feet and body, can be scaled to fit on the top of any skateboard.

The method of using a motion picture source in conjunction with a prepared maneuver diagram comprises first preparing a maneuver diagram through examination of the motion of the skilled artisan performing the specific maneuver. Once a diagram has been prepared, the symbols selected to represent start, stop or end points and motion direction representations, are correlated with symbols that are superimposed over the motion picture source based on the location and motion of the artisan's feet and/or body. Such superimposition can comprise the actual placement of the symbols within the images that are part of the sequence of images of a motion picture source. The symbols can be added using any of a variety of editing programs created and used for editing images on a computer. The most important aspect of the symbols superimposed in the motion picture source is that they are animated and capable of illustrating the motion of the skilled artisan's feet and/or body simultaneous with the motion of the artisan in the motion picture. Such superimposition provides an individual with clearer instruction of the skateboard maneuver allowing the individual to view the maneuver in action in conjunction with viewing the motion as illustrated in the maneuver diagram.

As used herein, “superimposed” and/or “superimposition” refer to the incorporation of animated, additional images, such as symbols, cartoon symbols, colored images, and the like, into a motion picture source that depicts a skilled skateboard trick artisan performing one or more skateboard maneuvers. Where the motion picture representation of the skateboard artisan performing one or more tricks, serves as a primary image and the symbol(s) is added to the motion picture source to provide correlated moments and images within the motion picture source that directly relate to the maneuver diagram as described herein.

The maneuver diagram and motion picture source can be provided to a user as a set, in for example a kit within a box or other sealed compartment such as a bag or folder or shrink-wrapped plastic display container. Such a kit can comprise one or more of, a maneuver diagram or parts thereof consisting of a full one piece maneuver diagram, or portions of a maneuver diagram, such as a front, tail and/or center section, each providing diagrammatic symbol illustrated instructions for performing one or more skateboard maneuvers, one or more motion picture sources, and a set of instructions for reading the diagram explaining what the symbols represent and the proper placement of the maneuver diagram.

I claim:

1. A skateboard maneuver diagram, wherein said diagram comprises symbols representing the start location, the motion and the end location for a users feet when performing one or more a skateboard maneuvers.

2. The diagram of claim 1, wherein said diagram is configured to be attached to the top of a skateboard.

3. The diagram of claim 2, wherein said symbols correlate with symbols
superimposed over images in a motion picture source.

4. The diagram of claim 3, wherein said motion picture source is a movie of a skateboard maneuver and said superimposed symbols move in concert with said motion picture source.

5. The diagram of claim 4, wherein said motion picture source is selected from the group consisting of one or more of, a flip book, a video tape, a cd-rom, a DVD, a VCD, or pixel generated image.

6. A instructional method for performing skateboard maneuvers comprising;
providing a diagram
providing a motion picture source,
wherein said diagram comprises symbols which represent the positions and motions for user's body and feet, and said diagram is configured for secure placement on a skateboard top surface, wherein said symbols correspond and correlate with symbols which are superimposed within said motion picture source, and
wherein said motion picture source comprises sequential images of a skateboard maneuver.

7. The method of claim 6, wherein said motion picture source is selected from the group consisting of one or more of; a flip book, a video tape, a cd-rom, a DVD, a VCD, or pixel generated image.

8. A system for providing instructions for performing a maneuver on a skateboard, wherein said system comprises;
a diagram
and a motion picture source,
wherein said diagram comprises symbols which represent the positions and motions of an individuals body and feet wherein said diagram is placed in a secure fashion on a skateboard, and said symbols correspond and correlate with symbols which are superimposed within said motion picture source, and wherein said motion picture source comprises sequential images of a skateboard maneuver.

9. A method for making a diagram of a skateboard maneuver comprising;
analyzing the motion of the feet and body of an individual performing a skateboard maneuver,
preparing a diagram comprising symbols which represent the placement and motion of the feet and body of said individual,
wherein said symbols provide start and end locations for a user's feet and body for performing said skateboard maneuver.

10 The method of claim 9, wherein said diagram is configured to be securely attached to a skateboard top surface.
